(19) United States
(12) Patent Application Publication
(10) Pub. No.: US 2013/0088437 A1
(43) Pub. Date: Apr. 11, 2013

(54) TERMINAL DEVICE

(71) Applicant: Masaomi Nishidate, Tokyo (JP)

(72) Inventor: Masaomi Nishidate, Tokyo (JP)

(73) Assignee: Sony Computer Entertainment Inc., Tokyo (JP)

(21) Appl. No.: 13/394,635

(22) PCT Filed: Jun. 7, 2011
(86) PCT No.: PCT/JP2011/063082

§ 371 Date: Dec. 7, 2012

(30) Foreign Application Priority Data
Jun. 14, 2010 (JP) 2010-134833
Jun. 14, 2010 (JP) 2010-134839

(51) Int. Cl. G06F 3/041

(52) U.S. Cl. CPC G06F 3/041
USPC 345/173

(57) ABSTRACT

A panel screen and a backside operation side 28 are arranged on a front side and a backside of a device main body, respectively. A control unit sets detection regions A to D in regions other than a specification region 40 on the backside operation side 28, and if a drag operation to a detection region A to D is detected, it executes preset processing corresponding to that detection region A to D.

### TECHNICAL FIELD

The present invention relates to a portable terminal device having a touch panel.

### BACKGROUND ART

JP 2003-330611A discloses an input device, which is provided with a display panel on the front side and a touch sensor on the backside, displays on the display panel a user's finger contact position on the touch sensor, and when the finger contact position and display of an operation button on the display panel overlap, it executes processing corresponding to that operation button.

### PRIOR ART DOCUMENTS

### Patent Documents

[Patent Document 1] JP 2003-330611A

### SUMMARY OF THE INVENTION

### Problem to be Solved by the Invention

However, the aforementioned conventional input device carries out the operation input of the operation button on the display panel indirectly through the backside touch sensor, and does not allow a wide variety of operation inputs.

The present invention is created with consideration of the above-described problem and aims to provide a terminal device that has good input operability and can respond to various operational inputs.

### Means of Solving the Problem

A terminal device according to a first aspect of the present invention includes a device main body; a panel screen arranged on a front side of the device main body; a first input detection means for detecting a press operation on the panel screen; a backside operation side arranged on a backside of the device main body; a second input detection means for detecting a press operation on the backside operation side; a region setting means for setting a detection region on the backside operation side; and a processing execution means for executing preset processing corresponding to the detection region when the second input detection means has detected a predetermined press operation in the detection region. The second input detection means detects a drag operation on the backside operation side. The backside operation side has a specification region. The region setting means sets the detection region in a region other than the specification region. The processing execution means executes preset processing corresponding to the detection region when the second input detection means has detected a drag operation from the specification region to the detection region.

A terminal device according to a second aspect of the present invention includes a device main body; a panel screen arranged on a front side of the device main body; a first input detection means for detecting a press operation on the panel screen; a backside operation side arranged on a backside of the device main body; a second input detection means for detecting a drag operation on the backside operation side; a region setting means for setting a detection region on the backside operation side; and a processing execution means for displaying on the panel screen an image that may be displayed moving forward and backward, and when the second input detection means has detected a drag operation in a predetermined direction in the detection region, displays the image displayed on the panel screen moving forward or backward. Forward speed and backward speed of the image are preset in accordance with an input position of a drag operation in a direction orthogonal to the predetermined direction. The processing execution means moves the image forward or backward at a speed in accordance with the input position of the drag operation in a direction orthogonal to the predetermined direction.

A terminal device according to a third aspect of the present invention includes a device main body; a panel screen arranged on a front side of the device main body; a first input detection means for detecting a press operation on the panel screen; a backside operation side arranged on a backside of the device main body; a second input detection means for detecting a drag operation on the backside operation side; a region setting means for setting a detection region on the backside operation side; and a processing execution means for displaying on the panel screen an image that may be displayed moving forward and backward, and when the second input detection means has detected a drag operation in a predetermined direction in the detection region, displays the image displayed on the panel screen moving forward or backward. The processing execution means, when having detected a drag operation of a predetermined distance or greater in the predetermined direction, changes a forward speed or backward speed of an image corresponding to a drag operation in the same direction as said drag operation, and in the case where another drag operation in the same direction as said drag operation is detected within a predetermined time after detection of the drag operation in the same direction as said drag operation, displays the image moving forward or backward at a changed speed.

### Result of Invention

According to the present invention, input operability is good and may respond to various operational inputs.

### BRIEF DESCRIPTION OF DRAWINGS

FIGS. 1(a) and 1(b) are exterior oblique perspectives of a terminal device according to an embodiment of the present invention, where FIG. 1(a) shows a front view and 1(b) shows a back view;

FIG. 2 is a block diagram schematically showing an exemplary system configuration of the main parts of the terminal device;

FIG. 3 is a block diagram schematically showing an exemplary software construction of the main parts of the terminal device;

FIG. 4 is an oblique perspective showing the terminal device in use;

FIG. 5 is a diagram showing an exemplary first region setting pattern;

FIG. 6 is a diagram showing another exemplary first region setting pattern;

FIG. 7 is a diagram showing yet another exemplary first region setting pattern;

FIG. 8 is a diagram showing a second region setting pattern;

FIG. 9 is a diagram showing a third region setting pattern;

FIG. 10 is a diagram showing an exemplary region setting pattern including a guide screen corresponding region; and

FIG. 11 is a diagram showing an exemplary guide screen.

### BEST MODE FOR CARRYING OUT THE INVENTION

An embodiment according to the present invention is described below with reference to the accompanying drawings. This embodiment is merely an example of the present invention and is not intended to limit the scope of the present invention, and may be arbitrarily modified within the scope of the present invention.

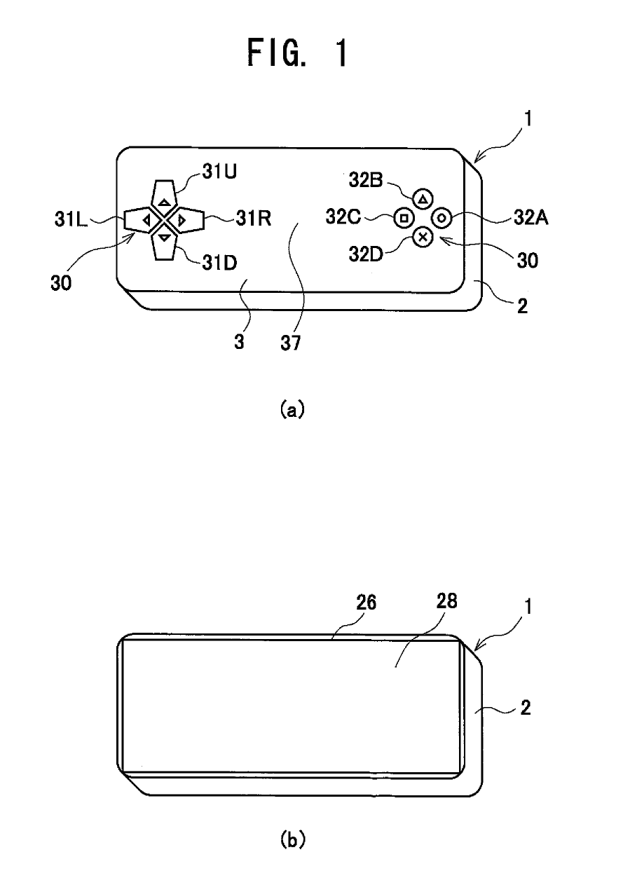

This embodiment is a portable terminal device 1, as shown in FIGS. 1(a) and 1(b).

### <External Structure of Terminal Device>

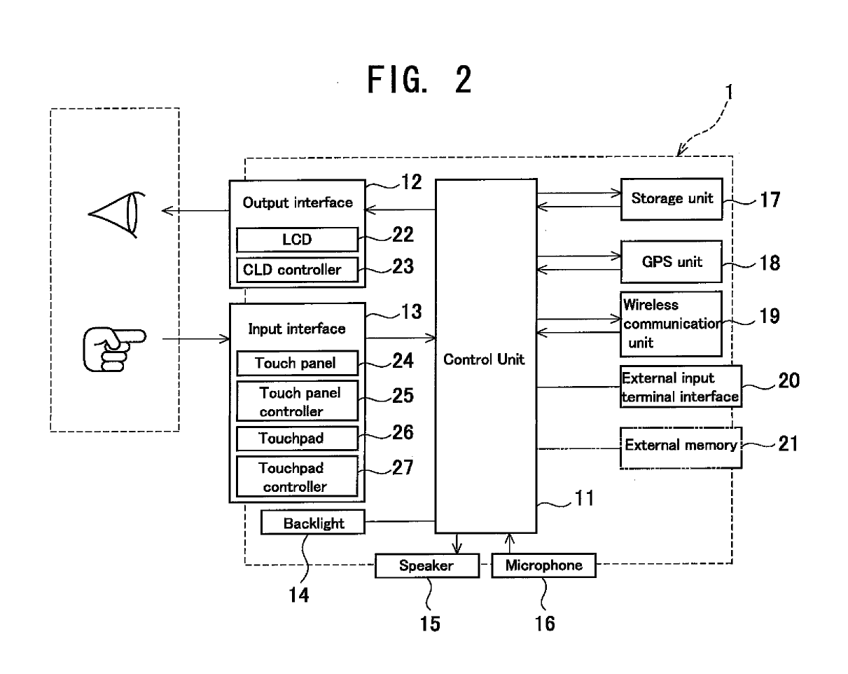

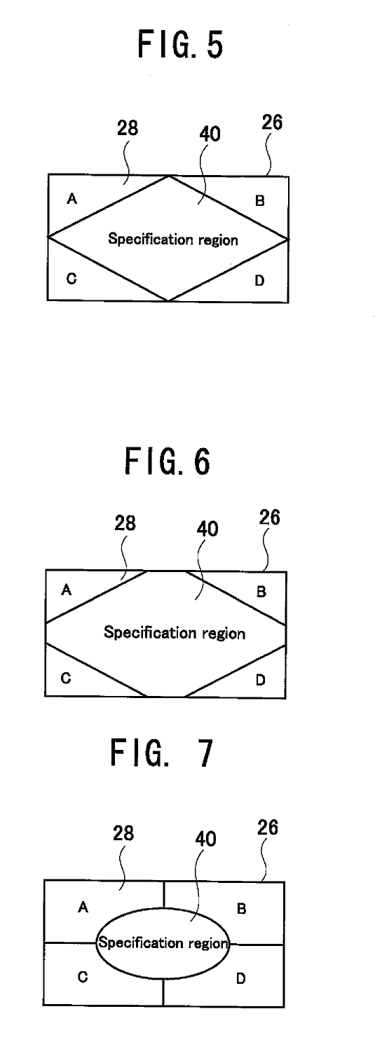

The terminal device 1 includes a rectangular plate-shaped device main body 2, a panel screen 3 arranged on the front side of the device main body 2, and a touchpad 26 arranged on the backside of the device main body 2. The terminal device 1 also includes a speaker 15 and a microphone 16 (shown in FIG. 2), and an infrared port, a USB terminal, an external memory holding unit, a recharging terminal, and a power switch, which are not shown in the drawing. The external memory holding unit holds an external memory 21 (shown in FIG. 2) such as a memory stick or a memory card. A user uses the terminal device 1 by grasping the short or long sides with both hands in a state where the panel screen 3 is facing him/her. The case of gripping the short sides (shown in FIG. 5) is referred to as horizontally-held use mode, and case of gripping the long sides is referred to as vertically-held use mode.

### <System Configuration of Terminal Device>

A system configuration of the terminal device 1 is described while referencing FIG. 2. FIG. 2 is a block diagram schematically showing an exemplary system configuration of the main parts of the terminal device 1.

The terminal device 1 includes a control unit 11, an output interface 12, an input interface 13, a backlight 14, the aforementioned speaker 15, the aforementioned microphone 16, a storage unit 17, a GPS unit 18, a wireless communication unit 19, an external input terminal interface 20, and related parts.

The storage unit 17 includes Read Only Memory (ROM) and a main memory made up of Random Access Memory (RAM).

The control unit 11 is constituted by a main control unit, which is made up of a central processing unit (CPU) and peripheral devices thereof, an image control unit, which is made up of a graphic processing unit (GPU) for rendering on a frame buffer, and a sound control unit, which is made up of a sound processing unit (SPU) for generating musical sounds, sound effects, and the like.

The main control unit includes the CPU, and a peripheral device control unit for controlling interruptions and direct memory access (DMA) transfer.

The sound control unit includes the SPU for generating musical sounds, sound effects and the like under control of the main control unit, and a sound buffer recorded with waveform data and the like by the SPU, where the musical sounds, sound effects and the like generated by the SPU are output from the speaker 15. The SPU includes an adaptive differential PCM (ADPCM) decoding function of reproducing ADPCM-encoded voice data, which is represented by 4-bit differential signals if it is, for example, 16-bit voice data, a reproducing function of generating sound effects and the like by reproducing the waveform data stored in the sound buffer, a modulating function of modulating and reproducing the waveform data stored in the sound buffer. Moreover, the SPU has a function of supplying the voice data received from the microphone 16 to the CPU. When a sound is input from the outside, the microphone 16 conducts A/D conversion thereof to a quantified number of bits using a predetermined sampling frequency so as to supply sound data to the SPU.

The image control unit includes a geometry transfer engine (GTE), the GPU, the frame buffer, and an image decoder. The GTE includes a parallel calculating mechanism, which executes multiple parallel calculations, for example, and carries out coordinate transformation, lighting calculation, and calculations of matrices, vectors, and the like at high speed in response to a calculation request from the CPU. The main control unit defines a three-dimensional model as a combination of basic polygons, such as a triangle or a quadrangle, based on calculation results from the GTE, and then sends to the GPU a draw instruction corresponding to each polygon for drawing a three-dimensional image. The GPU draws polygons or the like in the frame buffer in conformity with the draw instruction from the main control unit. The frame buffer is stored with images drawn by the GPU. This frame buffer is constituted by so-called dual port RAM allowing parallel processing: drawing by the GPU, transferring from the main memory of the storage unit 17, and reading out for display. Furthermore, aside from a display region for video output, a CLUT region, which is stored with a color look-up table (CLUT) referenced by the GPU when the GPU draws a polygon or the like, and a texture region, which is stored with materials (textures) that will be inserted (mapped) in the polygon or the like to be coordinate-transformed and then drawn by the GPU, are provided in the frame buffer. The CLUT region and the texture region are dynamically modified in response to modification of the display region. The image decoder decodes static image or moving image data, which has been stored in the main memory of the storage unit 17 and compressed and encoded through orthogonal transformation such as discrete cosine transformation, and then stores it in the main memory under the control of the main control unit.

The ROM of the storage unit 17 is stored with a program such as an operating system or the like, which controls each part of the terminal device 1. The CPU of the control unit 11 controls the entire terminal device 1 by reading out the operating system from the ROM to the main memory of the storage unit 17 and executing the read-out operating system. Moreover, the ROM is stored with various programs, such as a control program for controlling each part of the terminal device 1 and various peripheral devices connected to the terminal device 1, an image reproducing program for reproducing image content, and a game program for making the CPU implement a function of executing a game.

The main memory of the storage unit 17 is stored with the program read out from the ROM by the CPU, and various data such as data to be used when executing various programs.

The GPS unit 18 receives radio waves transmitted by satellite under control of the control unit 11, and outputs to the control unit 11 a request for positional information (latitude, longitude, altitude, etc.) of the terminal device 1 using these radio waves.

The wireless communication unit 19 carries out wireless communication with other terminal devices via the infrared port under control of the control unit 11.

The external input terminal interface 20 includes a USB terminal and a USB controller, and a USB connection is made with an external device via the USB terminal.

The external memory 21 held in the external memory holding unit is connected to the control unit 11 via a parallel I/O interface (PIO) and a serial I/O interface (SIO) omitted from the drawing.

The output interface 12 includes a liquid crystal display (LCD) 22 and an LCD controller 23. The LCD 22 is a module made up of an LCD panel, a driver circuit, and related parts. The LCD controller 23 has a built-in RAM that temporarily stores image data output from the frame buffer of the control unit 11, and reads out image data from the RAM at predetermined timings and outputs it to the LCD 22 through control by the control unit (main control unit) 11.

The input interface 13 includes a touch panel 24, a touch panel controller 25, a touchpad 26, and a touchpad controller 27. Both the touch panel 24 and the touchpad 26 according to this embodiment employ a resistance film system.

The touch panel 24 has a structure where multiple electrode sheets formed of clear electrode films are arranged with electrodes facing each other at uniform intervals, and is arranged on the display screen of the LCD 22 (LCD panel). A surface (outer surface) 24a of the touch panel 24 constitutes the panel screen 3 for receiving a press operation from a user's finger (primarily thumb) or a pen or the like, and when the panel screen 3 is depressed (press operation is performed) by a user's finger, pen or the like, the electrode sheets of the touch panel 24 make contact with each other, changing the resistance on the respective electrode sheets. The touch panel controller 25 detects change in resistance on the respective electrode sheets, thereby finding the depressed position (operation input position) as a coordinate value (plane coordinate value or polar coordinate value) and further finding intensity of the depression corresponding to the coordinate value as magnitude (absolute value) of amount of change in value of resistance, and then outputs to the control unit 11 the coordinate value and the magnitude of amount of change as operation input information (operation signal) on the front side. Note that a single operation input generates a wave of collective resistance values having a peak within a predetermined region, allowing detection thereof. When the touch panel controller 25 has detected such collective resistance values, it then outputs to the control unit 11 the coordinate value and the magnitude of amount of change at that peak as operation input information for a single operation input. Moreover, the touch panel controller 25 determines whether or not the collective resistance values have shifted. If it is determined to have shifted, the touch panel controller 25 outputs to the control unit 11 operation input information after shifting, where the information may indicate (for example, attaching the same identification information to the operation input information before and after shifting) that there are two pieces of operation input information representing two operation inputs (drag operation) carried out successively. Namely, the input interface 13 functions as a first input detecting means for detecting a press operation on the panel screen 3 by the user. Furthermore, the input interface 13 (touch panel 24) is a so-called multi-touch panel (multi-touch screen) capable of simultaneously detecting press operations at multiple positions on the panel screen 3, and the user may carry out operation inputs at multiple operation input positions simultaneously by pressing on the panel screen 3 with multiple fingers.

The touch panel 24 has a transparent, thin plate shape and is arranged closely to and above the display screen of the LCD 22. Therefore, an image on the display screen of the LCD 22 is easily visible from the panel screen 3 transmitting through the touch panel 24, where the LCD 22 and the touch panel 24 comprise a display means. Moreover, the position (apparent position) of the image on the LCD 22, which is seen on the panel screen 3 via the touch panel 24, and position (actual position) of the image on the display screen of the LCD 22 agree with hardly any misalignment.

The touchpad 26, as with the touch panel 24, also has a structure where multiple electrode sheets formed of clear electrode films are arranged with electrodes facing each other at uniform intervals. A surface (outer surface) of the touchpad 26 constitutes a backside operation side 28, which receives a press operation from a user's finger (primarily index finger and middle finger) or the like, and when the backside operation side 28 is depressed (press operation is performed) by a user's finger or the like, the electrode sheets of the touchpad 26 make contact with each other, changing the resistance on the respective electrode sheets. The touchpad controller 27 detects change in resistance on the respective electrode sheets, thereby finding the depressed position (operation input position) as a coordinate value (plane coordinate value or polar coordinate value) and also finding intensity of the depression corresponding to the coordinate value as magnitude (absolute value) of amount of change in the resistance value, and then outputs to the control unit 11 the coordinate value and the magnitude of amount of change as operation input information (operation signal) on the backside. Note that a single operation input generates a wave of collective resistance values having a peak within a predetermined region, allowing detection thereof. When the touchpad controller 27 has detected such collective resistance values, it then outputs to the control unit 11 the coordinate value and the magnitude of amount of change at that peak as operation input information for a single operation input. Moreover, the touchpad controller 27 determines whether or not the collective resistance value has shifted. If it is determined to have shifted, the touch panel controller 27 outputs to the control unit 11 operation input information after shifting, where the information may indicate (for example, by attaching the same identification information to the operation input information before and after shifting) that there are two pieces of operation input information representing two operation inputs (drag operation) carried out successively. In other words, the input interface 13 functions as a second input detecting means for detecting a press operation on the backside operation side 28 by the user. Furthermore, the input interface 13 (touchpad 26) is a so-called multi-touch screen capable of simultaneously detecting press operations at multiple positions on the backside operation side 28, and the user may carry out operation inputs at multiple operation input positions simultaneously by pressing on the backside operation side 28 with multiple fingers.

Note that the touch panel 24 and the touchpad 26 are not limited to the above resistance film system, as long as they have functions of detecting a press operation on the panel screen by a user's finger and detecting the position of the press operation. For example, instead of the resistance film system, various types of input interfaces, such as an electrical capacitance system, an image recognition system, and an optical system, may be employed. With the electrical capacitance system, an operation input position is detected by forming a low-potential electric field across the entire surface of the touch panel and detecting change in surface charge when a finger touches the touch panel. With the image recognition system, an operation input position is detected by multiple image sensors arranged near the LCD display screen taking an image of a finger or the like touching an LCD display screen and then by analyzing the taken image. Moreover, with the optical system, an operation input position is detected by a luminous object placed on one of longitudinal walls and one of lateral walls of peripheral walls surrounding an LCD display screen, and an optical receiver placed on the other longitudinal wall and lateral wall, detecting a longitudinal and a lateral position of light intercepted by a finger touching the display screen. In other words, with the image recognition system and the optical system, provision of a touch panel is unnecessary, where the LCD image screen is a panel screen for receiving a press operation from a user.

Furthermore, while the touch panel controller 25 and the touchpad controller 27 are displayed separately in FIG. 2, they may be built as a single controller.

The backlight 14 is arranged on the backside of the LCD 22 (LCD panel) and illuminates light from the backside of the LCD 22 toward the front side under control of the control unit 11. Note that the backlight 14 may also illuminate light according to control by the LCD controller 23.

### <Software Construction of Terminal Device>

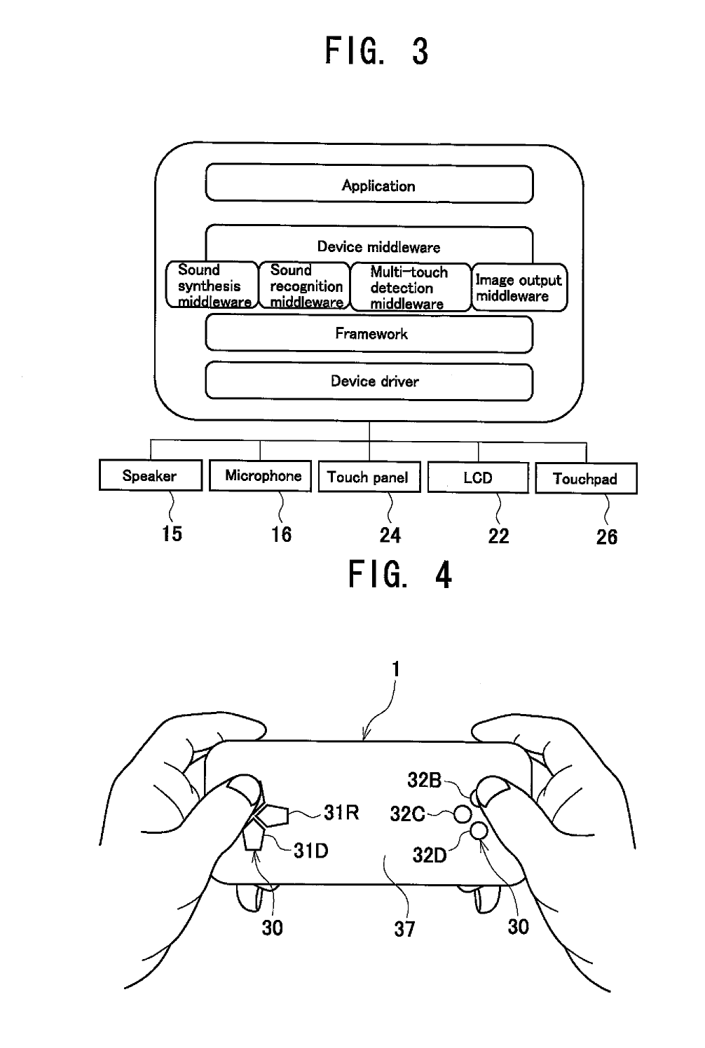

Next, a software construction of the terminal device 1 is described while referencing FIG. 3. FIG. 3 is a block diagram schematically showing an exemplary software construction of the main parts of the terminal device 1.

In the software construction of the terminal device 1, a device driver layer, a framework layer, a device middleware layer, and an application layer are provided in order from the bottom.

The device driver layer is software for operating the control unit 11 and hardware connected to the control unit 11. For example, a device driver for operating an audio conversion module, an LCD driver for operating the LCD, a driver for operating the backlight, and the like are included if necessary.

The framework layer is software for providing a general-purpose function to an application program, and managing various resources to be operated by device drivers. The framework layer informs a device driver of an instruction from an application program executed in the middleware layer to be described later or the application layer, for example. Moreover, the framework layer provides basic functions shared by many application software, such as inputting and outputting data to and from the storage unit 17 and the external memory 21, and managing an input-output function such as an operation input from the touch panel 24 or a screen output to the LCD 22, thereby managing the entire system.

The middleware layer is constituted by middleware or software providing to the application programs more advanced basic functions than the framework and operating on the framework. Sound synthesis middleware for providing basic functions of technology of synthesizing output sound from the speaker 15, sound recognition middleware for providing basic functions of technology of recognizing sound input from the microphone 16, multi-touch detection middleware for providing basic functions of technology of detecting operation inputs from the touch panel 24 and the touchpad 26, and image output middleware for providing basic functions of technology of outputting an image to the LCD 22 are provided herein.

In the application layer or uppermost layer, various application programs are executed. The terminal device 1 is provided with, for example, an application manager for managing these application software and a development environment as well as a communication application, a web browser, a file conversion application, an audio player, a music search application, music streaming, a recording tool, a photo viewer, a text editor, individual applications such as game applications, a menu display tool, and a setup tool.

### <Functional Structure for Operation Input>

A structure of operation input management processing implemented by executing an operation input management program by the control unit 11 of the terminal device 1 having the above system configuration and software construction is described. The operation input management processing includes front side input management processing in accordance with operation input information from the touch panel 24, and backside input management processing in accordance with operation input information from the touchpad 26. Note that the operation input management program may be stored as an independent application in the storage unit 17, or it may be in the storage unit 17 or external memory 21 in a state where it is included in respective applications such as game applications or the like. Moreover, in the case where the operation input management program is stored as an independent application, it may be executed under management of another application. Note that hereafter, processing executed by the control unit 11 along with the operation input management processing is referred to as main processing if not described otherwise.

### <Description of Front Side Input Management Processing>

In the front side input management processing, the control unit 11 specifies an input display pattern from multiple prestored input display patterns, and displays at predetermined positions on the panel screen 3 multiple input position display icons 30 denoting operation input positions in accordance with the specified input display pattern. For example, a game button display pattern (shown in FIG. 1) suitable for game execution, a keyboard display pattern suitable for character entry when creating an e-mail or the like, a keyboard display pattern suitable for music data input, and similar patterns are set as the multiple input display patterns.

A region in which the input position display icons 30 are not displayed on the panel screen 3 is a main display region (e.g., a display region for a game screen for a game application) 37 for displaying an output image through the main processing. Since size and top and bottom of the main display region 37 change according to input display pattern, the control unit 11 changes the orientation or size of an image to be displayed in the main display region 37 in accordance with the specified input display pattern if necessary.

For example, in the game button display pattern, as shown in FIG. 1, an up key icon 31U, a down key icon 31D, a left key icon 31L, and a right key icon 31R are displayed as input position display icons 30 in a right side region on the panel screen 3 in the horizontally-held use mode, and a circle marked button icon 32A, a triangle marked button icon 32B, a square marked button icon 32C, and a cross marked button icon 32D are displayed as input position display icons 30 in a right side region on the panel screen 3. The respective button icons 31U, 31D, 31L, 31R, 32A, 32B, 32C, and 32D are also displayed with respective signs (e.g., an upward arrow with the up key icon 31U and a circle sign with the circle marked button icon 32A) specifying those respective buttons.

The control unit 11 may specify an input display pattern preset immediately after the operation input management processing has started, and specify an input display pattern in response to an operation input from a subsequent user, or it may specify a predetermined input display pattern in accordance with the main processing (e.g., game application).

Moreover, the control unit 11 limits input display patterns that are selectable by the user in accordance with the main processing to be executed. For example, selection of the keyboard display pattern is prohibited in the case of an application requiring a large area as the main display region 37 and the main processing to be executed not requiring input of music data.

If operation input information on the front side of the input interface 13 in a state where a certain input display pattern is displayed is received, the control unit 11 determines whether or not the coordinate position indicated by that operation input information is a position (operation input position) corresponding to the display region of an input position display icon 30. If they correspond to each other, the control unit 11 judges that a predetermined operation input from the user has been performed, and then supplies to the main processing a control signal pre-associated to that input position display icon 30. Note that the range of the above operation input position may be the entire or a part of the display region of the input position display icons 30. Moreover, when the main processing corresponds to a drag operation and a drag operation has been detected, a control signal indicating the drag operation is output to the main processing.

### <Description of Backside Input Management Processing>

In the backside input management processing, the control unit 11 specifies a region setting pattern from multiple prestored region setting patterns, and sets at least one detection region on the backside operation side 28 in accordance with the specification region setting pattern. When the control unit 11 sets a region setting pattern, it then executes pre-associated processing for an operation input to the detection region. In other words, the control unit 11 functions as a region setting means for setting a detection region on the backside operation side 28, as well as a processing execution means for executing preset processing for the detection region when the input interface 13 has detected a predetermined press operation to the detection region.

Operation inputs detectable by the control unit 11 via the touchpad 26 include simple contact (touch operation), a drag operation of moving a contact position while still making contact, a tap operation of touching for an instant and immediately moving away, and similar operations. When depressed intensity (magnitude of change in resistance value) entered by the touchpad controller 27 has exceeded a predetermined threshold, and the depressed intensity that has exceeded the predetermined threshold in a predetermined range is continuously entered for at least a predetermined period, the control unit 11 detects that operation output as a touch operation. When the depressed intensity entered by the touchpad controller 27 has moved a predetermined distance or greater with that intensity exceeding a predetermined threshold, the control unit 11 detects it as a drag operation. When the depressed intensity entered by the touchpad controller 27 has exceeded a predetermined threshold and is equal to or less than the predetermined threshold within a predetermined set period, the control unit 11 detects the operation input as a tap operation. Moreover, in order to find a drag operation, the control unit 11 detects drag direction and drag distance based on the input operation input position.

The control unit 11 may specify a region setting pattern preset immediately after the operation input management processing has started, and specify a region setting pattern in response to an operation input from a subsequent user, or it may specify a predetermined region setting pattern in accordance with main processing (e.g., game application) to be executed or an input display pattern displayed on the panel screen 3. Alternatively, the control unit 11 may set a backside operation input invalid state in which operation inputs to the touchpad 26 are invalid in accordance with a predetermined operation input from the user on the panel screen 3 or the like.

Next, examples of region setting patterns set by the control unit 11 and processing executed by the control unit 11 in correspondence to those patterns are described. Note that left and right directions in the description of the backside operation side 28 given below are those when viewing the backside operation side 28, and are opposite to left and right directions for the user when grasping and using the terminal device 1. In other words, the left side of the backside operation side 28 is grasped by the user's right hand, and the right side is grasped by the user's left hand.

### <First Region Setting Pattern>

An example of a first region setting pattern is illustrated in FIG. 5. In the first region setting pattern, multiple detection regions (detection regions A to D in four places in this example) and a specification region 40 adjacent to the respective detection regions A to D are set. The specification region 40 functions as an activation region (authorization region), and when a drag operation from the specification region 40 to one of the detection regions A to D is detected, the control unit 11 executes predetermined processing in correspondence to that detection region. Note that when multiple operation inputs are detected, the control unit 11 makes all of the detected operation inputs as invalid.

In the example of FIG. 5, a rhombic specification region 40 is set in the central portion of the backside operation side 28 in the horizontally-held use mode, and the detection regions A to D are set in the outer upper left area, upper right area, lower left area, and lower right area of the specification region 40, respectively. In other words, the specification region 40 always lays in the middle of the detection regions A to D, and a finger moving (sliding) from one detection region to another always touches the specification region 40 during that movement. Note that the specification region 40 may be adjacent to the multiple detection regions A to D, the detection regions may be arranged completely detached from each other as illustrated in FIG. 6, for example, or the detection regions may be arranged adjacent to each other as illustrated in FIG. 7.

The first region setting pattern is suitably used when displaying information preset in an hierarchical format on the panel screen 3, such as switching-over of application windows, hierarchical display of folders on the panel screen 3 or the like. The control unit 11 associates the detection regions A to D to multiple pieces of information included in the respective layers in compliance with a predetermined rule. In this embodiment, the detection regions A to D are associated according to a setting order of the information in the respective layers. More specifically, the detection region A is associated to the first information in the setting order, the detection region B is associated to the second information, the detection region C is associated to the third information, and the detection region D is associated to the fourth information. When a drag operation from the specification region 40 to one of the detection regions A to D specification region 40 is detected, the control unit 11 selects information corresponding to that detection region and displays that information on the panel screen 3. Moreover, if the user releases the finger from that detection region after this drag operation, the control unit 11 holds the information selected by the drag operation and maintains the display as an established screen on the panel screen 3. In this state, the user may perform an operation input to the panel screen 3 so as to make the control unit 11 execute predetermined processing. Furthermore, tapping a finger on the specification region 40 (detecting a tap operation to the specification region 40) ends the display of the confirmation screen (closes the confirmation screen).

For example, when the main menu is associated to the detection region A, other information is associated to the other respective detection regions B to D, and four submenus are aligned in a predetermined order in a lower layer of the main menu, the user places a finger in the specification region 40 and slides it to the detection region A so that the control unit 11 executes drive processing for the main menu and displays content of the main menu on the panel screen 3. If the user returns the finger in this state to the specification region 40 and slides it to one of the detection regions A to D, the control unit 11 displays on the panel screen 3 a submenu corresponding to that detection region (the first submenu in the case where the destination is the detection region A, the second submenu in the case of the detection region B, the third submenu in the case of the detection region C, and the fourth submenu in the case of the detection region D). Moreover, when displayable information is set sequentially in a lower layer of the respective submenus, the user may repeat the same operation input so as to display information of a further lower layer on the panel screen 3.

Furthermore, the case where folders are set up hierarchically is the same as the above cases, and the user may repeat sliding from the specification region 40 to one of the detection regions A to D so as to display content of a further lower layer.

In this manner, use of the first region setting pattern allows the user to display desired information from the information set up hierarchically through a simple operation.

### <Modification of First Region Setting Pattern>

In the first region setting pattern, while the specification region 40 is set as a responsive region in which the result from detecting an operation input from the user in the same manner for the detection regions A to D is to be reflected, the specification region 40 may be set as an unresponsive region in which the detection is made invalid, or not detect the operation input from the user. In this case, sliding from the specification region 40 to one of the detection regions A to D is detected through a drag operation from the boundary of the specification region 40 and the detection regions A to D to inside of one of the detection regions A to D.

Alternatively, the specification region may be set as a responsive region arranged in the central area of an unresponsive region. In this case, sliding from the specification region to one of the detection regions A to D is detected through a touch operation in the specification region and a drag operation from the boundary of the unresponsive region and the detection regions A to D to inside of one of the detection regions A to D.

### <Second Region Setting Pattern>

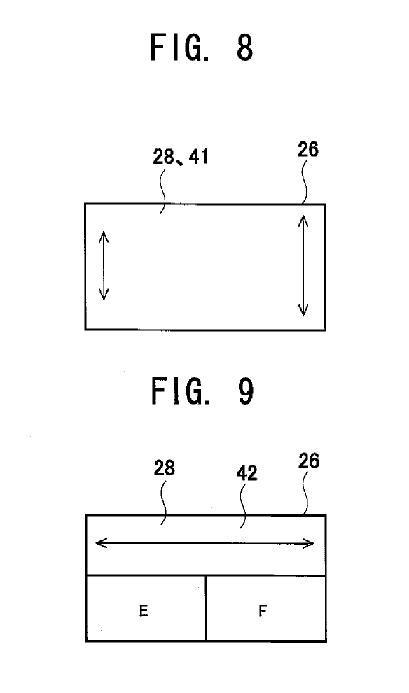

An example of a second region setting pattern is illustrated in FIG. 8. A single detection region 41 is set in the second region setting pattern. When a drag operation in a predetermined direction in the detection region 41 is detected in a state where an image that may be displayed moving forward and backward is displayed on the panel screen 3, the control unit 11 displays the image displayed on the panel screen 3 moving forward or backward. Moreover, forward speed and backward speed (amount of going forward and backward in unit moving distance of a drag operation in a predetermined direction) of the image are preset in accordance with an input position (coordinate value) of the drag operation in an orthogonal direction to the predetermined direction, and the control unit 11 makes the image move forward or backward at a speed in accordance with the input position of the drag operation in the orthogonal direction to the predetermined direction. A scrollable screen, a moving image or the like is included in the image that may be displayed moving forward and backward. In the case of a scrollable screen, the speed of moving the image forward or backward corresponds to the scrolling speed, and in the case of a moving image, it corresponds to amount of movement of the moving image. Note that when multiple operation inputs are detected, the control unit 11 makes all of the detected operation inputs as invalid.

In the example given in FIG. 8, the detection region 41, which has an up-and-down direction as the above predetermined direction, is set across most of the entire backside operation side 28 in the horizontally-held use mode. Moreover, speed of input positions is set such that the further the input position of the drag operation is on the right side, the higher the speed of moving the image forward or backward, and the further the input position of the drag operation is on the left side, the lower the speed. The image moves forward by a downward drag operation, and it moves backward by an upward drag operation.

In the case of scrolling a screen (screen on which a comic, story, or the like is displayed) using the second region setting pattern, the user places a finger in the detection region 41 and slides it upward or downward. The user slides it to the right side when wanting to increase the scrolling speed, and slides it to the right side when wanting to decrease the speed. The control unit 11 that has detected the drag operation in the detection region 41 scrolls and displays the image in a direction corresponding to the dragging direction at the speed corresponding to the input position of the drag operation. Note that sliding at an angle allows gradual increase (or decrease) in scrolling speed.

Moreover, when reproducing a moving image, through execution of an operation input using the second region setting pattern, the user may reduce or increase the amount of movement of the moving image so as to fast forward or rewind, as in the case of scrolling.

In this manner, use of the second region setting pattern allows easy forward and backward display of an image at a predetermined speed that is changeable steplessly.

### <Third Region Setting Pattern>

An example of a third region setting pattern is illustrated in FIG. 9. Three detection regions (a detection region 42 and detection regions E and F) are set in the third region setting pattern. When a drag operation in a predetermined direction in the detection region 42 is detected in a state where an image that may be displayed moving forward and backward is displayed on the panel screen 3, the control unit 11 displays the image displayed on the panel screen 3 moving forward or backward. Moreover, when a drag operation of a predetermined distance or greater in a predetermined direction is detected, the control unit 11 changes forward speed or backward speed (amount of going forward and backward in unit moving distance of a drag operation in a predetermined direction) of the image corresponding to the drag operation in the same direction. After detection of the drag operation for a predetermined distance or greater in the predetermined direction, the control unit 11 moves the image forward or backward at a changed speed when a drag operation in the same direction within a predetermined time is detected again, and changes back to the prior speed when a drag operation in the same direction is detected even if the predetermined time has been reached. Note that while change in forward speed and backward speed of the image may be sped up or slowed down, the case of speeding up is described in this embodiment. Moreover, while a scrollable screen, moving image or the like is included in the image that may be displayed moving forward and backward, the case of a moving image is described in this embodiment. Furthermore, when multiple operation inputs are detected, the control unit 11 makes all of the detected operation inputs as invalid.

In the example given in FIG. 9, the detection region 42, which has an up-and-down direction as the above predetermined direction, is set in the upper half of the backside operation side 28 in the horizontally-held use mode. The moving image is fast forwarded by a drag operation to the left side, and it is rewound by a drag operation to the right side. Moreover, the lower half region of the backside operation side 28 is divided into left and right sides, where the detection region E is set in the left side region, and the detection region F is set in the right side region.

In the case of reproducing a moving image using the third region setting pattern, if a tap operation in the detection region E is detected before or during reproduction of the moving image, the control unit 11 displays a list screen of reproducible moving images on the panel screen 3. At this time, in the case of reproducing a moving image, reproduction thereof is temporarily stopped. If a drag operation in the detection region E is detected in a state where a list screen of reproducible moving images is displayed, the control unit 11 displays a cursor icon moving within the list screen of the moving images in accordance with the detected drag operation. The user performs a drag operation while watching the cursor icon, brings the cursor icon to be on a moving image desired to be reproduced, and then performs a tap operation in that state. The image to be reproduced is specified by this tap operation, and the control unit 11 then starts reproduction of the moving image. In addition, if a tap operation in the detection region F is detected in a state where the list screen of reproducible moving images is displayed, the control unit 11 ends display of the list screen, and when that moving image is temporarily stopped, it resumes reproduction of a moving image. When there is no moving image being temporarily stopped, it displays to that effect on the panel screen 3.

Moreover, if a drag operation in the left and right directions of the detection region is detected during reproduction of a moving image, the control unit 11 moves a moving image in a direction corresponding to the drag direction, fast forwards or rewinds it, and then reproduces the moving image. The user may repeat sliding for a predetermined distance or greater in the same direction so as to gradually increase the amount of movement per unit moving distance of the drag operation and increase the speed of fast forwarding or rewinding.

### <Region Setting Pattern Including Guide Display Corresponding Region>

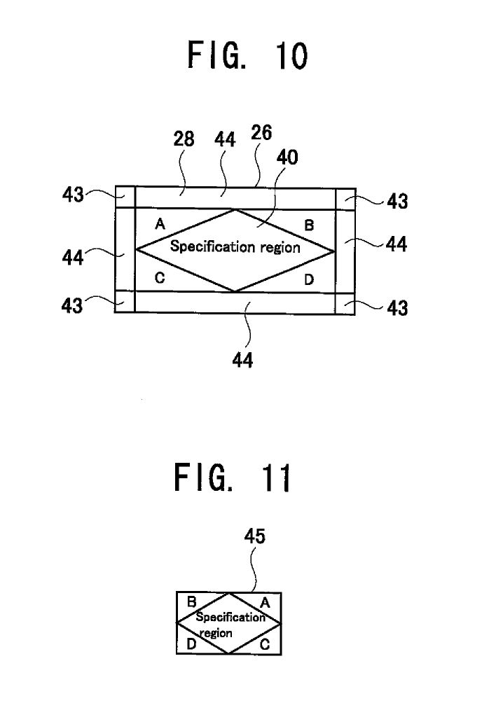

An example of a region setting pattern including a guide display corresponding region is illustrated in FIG. 10. This example adds guide display corresponding regions 43 to the first region setting pattern, where the guide display corresponding regions 43 are set in the four corner portions of the edges of the backside operation side 28. Note that regions 44 excluding the guide display corresponding regions 43 of the edges of the backside operation side 28 are unresponsive regions. Moreover, the detection regions A to D and the specification region 40 are set on the inside of the edges of the backside operation side 28. Alternatively, the guide display corresponding regions 43 may be added to another region setting pattern.

If a tap operation in a guide display corresponding region 43 is detected, the control unit 11 displays on the panel screen 3 a guide screen 45 (illustrated in FIG. 11) showing positions of the detection regions A to D and the specification region 40, and if a tap operation in a guide display corresponding region 43 is detected again, display of the guide screen 45 is terminated (the guide screen 45 is closed.) Note that since the guide screen 45 of FIG. 11 is showing a state displayed on the panel screen 3, left and right positional relationships of the detection regions A and C and the detection regions B and D are different.

The user may perform a tap operation in a guide screen corresponding region 43 so as to display the guide screen 45 and perform an operation input to the backside operation side 28 while watching the guide screen 45.

Moreover, since the respective guide screen corresponding regions 43 are arranged near the four corners of the operation terminal 1, the user may easily know the positions of the guide screen corresponding regions 43 by touch of a finger.

### [Modification 1]

The first region setting pattern may be applied for display of multiple windows (e.g., a window displaying statuses of a weapon, a window displaying members participating in a game, and the like) to be used frequently during game execution. When a window displaying statuses of weapons is first in a setting order of multiple windows used in a game, a user executing a game may perform a drag operation from the specification region 40 to the detection region A so as to display the window displaying statuses of weapons, and perform a predetermined operation input on the touch panel 24 while that window is displayed so as to change the setting.

### [Modification 2]

A detection region combining the detection region 41 of the second region setting pattern and the detection region 42 of the third region setting pattern may also be set up.

### [Modification 3]

While in the above embodiment, the case of providing the touch panel 24 and the touchpad 26 on the front side and backside of the terminal device 1 constituted from a single frame has been described, when structuring the terminal device from two members joined slidably, the touch panel 24 may be provided on the front side of one of the parts, and the touchpad 26 provided on the backside of the other part.

The descriptions of the above embodiments are merely examples of the present invention. The present invention is not limited to the respective embodiments given above, and it is needless to say that various changes may be made without departing from the spirit or scope of the present invention.

### INDUSTRIAL APPLICABILITY

The present invention is applicable to terminal devices having a touch panel.

[Description of Reference Numerals]

1 terminal device, 2 device main body, 3 panel screen, 11 control unit,
12 output interface, 13 input interface, 22 LED, 24 touch panel, 26
touchpad, 28 backside operation side, 40 specification region, 41, 42, 42,
A, B, C, D, E, F detection region, 43 guide corresponding region, 44
guide display.

1. A portable terminal device, comprising:
a device main body;
a panel screen arranged on a front side of the device main body;
a first input detection means for detecting a press operation on the panel screen;
a backside operation side arranged on a backside of the device main body;
a second input detection means for detecting a press operation on the backside operation side;
a region setting means for setting a detection region on the backside operation side; and
a processing execution means for executing preset processing corresponding to the detection region when the second input detection means has detected a predetermined press operation in the detection region, wherein
the second input detection means detects a drag operation on the backside operation side,
the backside operation side has a specification region,
the region setting means sets the detection region in a region other than the specification region, and
the processing execution means executes preset processing corresponding to the detection region when the second input detection means has detected a drag operation from the specification region to the detection region.

2. The terminal device of claim 1, wherein
the region setting means sets the detection region in plurality,
the processing execution means associates a plurality of pieces of information included in respective layers of a plurality of pieces of information set up hierarchically, and the plurality of detection regions in compliance with a predetermined rule, and
the processing execution means displays the information associated in the detection regions on the panel screen when the second input detection means has detected a drag operation from the specification region to the detection region.

3. The terminal device of claim 1, wherein
the backside operation side has an unresponsive region in which the operation input is not detected or detection is made invalid, and
the unresponsive region comprises the specification region.

4. The terminal device of claim 1, wherein
the second input detection means detects a tap operation on the backside operation side,
the region setting means sets a panel display corresponding region in a region other than the specification region and the detection regions, and
the processing execution means displays on the panel screen a guide screen showing positions of the specification region and the detection regions on the backside operation side when the second input detection means has detected a tap operation in the panel display corresponding region.

5. A portable terminal device, comprising:
a device main body;
a panel screen arranged on a front side of the device main body;
a first input detection means for detecting a press operation on the panel screen;
a backside operation side arranged on a backside of the device main body;
a second input detection means for detecting a drag operation on the backside operation side;
a region setting means for setting a detection region on the backside operation side; and
a processing execution means for displaying on the panel screen an image that may be displayed moving forward and backward, and when the second input detection means has detected a drag operation in a predetermined direction in the detection region, displays the image displayed on the panel screen moving forward or backward, wherein
forward speed and backward speed of the image are preset in accordance with an input position of a drag operation in a direction orthogonal to the predetermined direction, and
the processing execution means moves the image forward or backward at a speed in accordance with the input position of the drag operation in a direction orthogonal to the predetermined direction.

6. A portable terminal device, comprising:
a device main body;
a panel screen arranged on a front side of the device main body;
a first input detection means for detecting a press operation on the panel screen;
a backside operation side arranged on a backside of the device main body;
a second input detection means for detecting a drag operation on the backside operation side;
a region setting means for setting a detection region on the backside operation side; and
a processing execution means for displaying on the panel screen an image that may be displayed moving forward and backward, and when the second input detection means has detected a drag operation in a predetermined direction in the detection region, displays the image displayed on the panel screen moving forward or backward, wherein
the processing execution means, when having detected a drag operation of a predetermined distance or greater in the predetermined direction, changes a forward speed or backward speed of an image corresponding to a drag operation in the same direction as said drag operation, and in the case where another drag operation in the same direction as said drag operation is detected within a predetermined time after detection of the drag operation in the same direction as said drag operation, displays the image moving forward or backward at a changed speed.

7. The terminal device of claim 6, wherein
the second input detection means detects a tap operation on the backside operation side,
the region setting means sets a panel display corresponding region in a region other than the detection region, and
the processing execution means displays on the panel screen a guide screen showing positions of the specification region and the detection regions on the backside operation side when the second input detection means has detected a tap operation in the panel display corresponding region.

8. The terminal device of claim 5, wherein
the second input detection means detects a tap operation on the backside operation side,
the region setting means sets a panel display corresponding region in a region other than the detection region, and
the processing execution means displays on the panel screen a guide screen showing positions of the specification region and the detection regions on the backside operation side when the second input detection means has detected a tap operation in the panel display corresponding region.
